(19) United States
(12) Patent Application Publication
(10) Pub. No.: US 2022/0274306 A1
(43) Pub. Date: Sep. 1, 2022

(54) OPERATING STATE MANAGEMENT DEVICE, OPERATING STATE MANAGEMENT SYSTEM, AND OPERATING STATE MANAGEMENT METHOD

(71) Applicant: KABUSHIKI KAISHA TOSHIBA, Tokyo (JP)

(72) Inventors: Satoshi SAYAMA, Yokohama (JP); Kosuke ADACHI, Yokohama (JP); Hiroaki NAKAMURA, Kawasaki (JP)

(73) Assignee: KABUSHIKI KAISHA TOSHIBA, Tokyo (JP)

(21) Appl. No.: 17/447,739

(22) Filed: Sep. 15, 2021

(30) Foreign Application Priority Data
Mar. 1, 2021 (JP) 2021-031763

(51) Int. Cl. B29C 45/76; G05B 15/02

(52) U.S. Cl. CPC B29C 45/766; G05B 15/02

(57) ABSTRACT

According to one embodiment, an operating state management device includes a first memory, a processor, and a second memory. The first memory is configured to store, in each of a plurality of operating state management target devices, feature patterns of detection states of a plurality of sensors that detect states of individual components in association with operating states. The processor is configured to compare patterns corresponding to actual detection states of the plurality of sensors with the feature patterns stored in the first memory, and determine operating states. The second memory is configured to store the determined operating states in time series.

### CROSS-REFERENCE TO RELATED APPLICATIONS

This application is based upon and claims the benefit of priority from Japanese Patent Application No. 2021-031763, filed on Mar. 1, 2021, the entire contents of which are incorporated herein by reference.

### FIELD

Embodiments described herein relate generally to an operating state management device, an operating state management system, and an operating state management method.

### BACKGROUND

Examples of operation modes of an injection molding machine include a full-automatic mode, a semi-automatic mode, a manual mode, a preparation mode, a stop mode, and the like.

In an operating state management device for a plurality of injection molding machines constituting a conventional injection molding system, how to grasp loss has been an important issue in order to improve efficiency and an operating rate in a manufacturing site.

However, in conventional component manufacturing plants, the injection molding machines are held in the number of several tens to more than 100, making it more difficult to grasp the loss.

This has caused a problem that although it is possible to grasp whether each injection molding machine is in mass production in the full-automatic mode, it is not possible, in other operation modes, to grasp an accurate operating rate, leading to a difficulty in improving productivity and an operating rate.

In addition, although data acquisition is possible with manual work by an operator, it has been inefficient from the viewpoint of accuracy deterioration and data collection efficiency, and thus, digitalized high-accuracy data acquisition has been desired from the viewpoint of improvement in workability, reduction in loss time, and improvement in productivity and operating rate.

The present invention has been made in view of the above, and aims to provide an operating state management device, an operating state management system, and an operating state management method, which are capable of grasping an accurate operating rate regardless of an operation mode.

### BRIEF DESCRIPTION OF THE DRAWINGS

FIG. 1 is a schematic block diagram of an injection molding machine abnormality detection system;

FIG. 2 is a diagram of a main part of an injection molding machine to which an injection molding machine abnormality detection system is applied;

FIG. 3 is a functional block diagram of an operating state management device;

FIG. 4 is a diagram illustrating an application example of various sensors;

FIG. 5 is a diagram illustrating a specific example of abnormality detection;

FIG. 6 is a diagram illustrating a feature pattern corresponding to a detection state of each of sensors at the time of mass production;

FIG. 7 is a diagram illustrating a feature pattern corresponding to a detection state of each of sensors at the time of mold setup;

FIG. 8 is a diagram illustrating a feature pattern corresponding to a detection state of each of sensors at the time of mold breakage/repair;

FIG. 9 is a diagram illustrating a feature pattern corresponding to a detection state of each of sensors at the time of molding condition adjustment;

FIG. 10 is a diagram illustrating a feature pattern corresponding to a detection state of each of sensors at the time of resin change;

FIG. 11 is a diagram illustrating a feature pattern corresponding to a detection state of each of sensors at the time of pre-mass-production startup;

FIG. 12 is a diagram illustrating a feature pattern corresponding to a detection state of each of sensors at the time of a molding machine failure (alarm activation);

FIG. 13 is a processing flowchart at the time of operation of the operating state management device; and

FIG. 14 is a diagram illustrating a display example of an analysis result.

### DETAILED DESCRIPTION

According to one embodiment, an operating state management device includes a first memory, a processor, and a second memory. The first memory is configured to store, in each of a plurality of operating state management target devices, feature patterns of detection states of a plurality of sensors that detect states of individual components in association with operating states. The processor is configured to compare patterns corresponding to actual detection states of the plurality of sensors with the feature patterns stored in the first memory, and determine operating states. The second memory is configured to store the determined operating states in time series.

Now, embodiments will be described in detail with reference to the drawings.

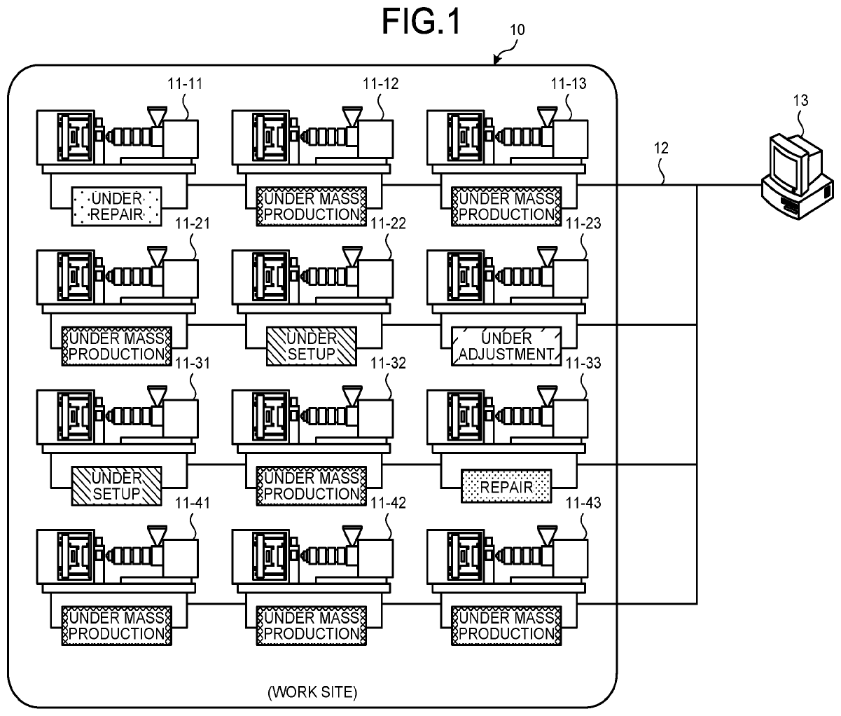

FIG. 1 is a schematic block diagram of an injection molding system including an operating state management device according to an embodiment.

An injection molding system 10 includes: a plurality of injection molding devices 11-11 to 11-13, 11-21 to 11-23, 11-31 to 11-33, and 11-41 to 11-43; and an operating state management device 13 that is connected to the injection molding devices 11-11 to 11-13, 11-21 to 11-23, 11-31 to 11-33, and 11-41 to 11-43 via a communication network 12 and manages the operating states of the injection molding devices 11-11 to 11-13, 11-21 to 11-23, 11-31 to 11-33, and 11-41 to 11-43.

In the following description, when there is no need to distinguish between the injection molding devices 11-11 to 11-13, 11-21 to 11-23, 11-31 to 11-33, and 11-41 to 11-43, the injection molding device is denoted as an injection molding device 11.

Here, an example of a loss factor in an injection molding device will be described.

Examples of the loss factor include the following 13 factors.

(1) Mold setup

(2) Auxiliary material shortage

(3) Pre-mass-production startup

(4) Extractor repair

(5) Molding condition adjustment

(6) Mold breakage/repair

(7) Chiller breakage

(8) Meeting

(9) Labor shortage

(10) Resin change

(11) Molding machine failure

(12) New model development trial

(13) Device maintenance

Based on actual data, main loss factors having a greater influence were narrowed down from among the above-described loss factors. Here, the “greater influence” means that it accounts for approximately 80% of the loss factor.

The present embodiment defines seven types of main loss factors (1) to (7) as described below. The operating state management is performed assuming eight types of states including (0) Mass production state with no loss, in addition to the seven factors.

(0) Mass production

(1) Mold setup

(2) Mold breakage/repair

(3) Molding condition adjustment

(4) Resin change

(5) Pre-mass-production startup

(6) Molding machine failure

(7) Others (loss factors other than the above)

At the time of performing the above detection, various sensors are disposed at predetermined positions appropriate for individual purposes. The sensors include: a temperature sensor (for example, a thermocouple) that detects the cylinder temperature; a position sensor (for example, a time of flight (TOF) sensor and a reed switch) that detects the position of the injection unit; a position sensor (for example, a time of flight (TOF) sensor) that detects the movement on the operation side; a brightness sensor (for example, an illuminance sensor) that detects the brightness of a beacon lamp; a position sensor (for example, the reed switch) that detects the open/closed state of an operation door of an injection chamber; a human sensor (for example, a time of flight (TOF) sensor and an optical [infrared ray, laser] sensor) that detects the presence or absence of intrusion of a human entering a predetermined area; and a sensor that detects the presence or absence of a mold (for example, a time of flight (TOF) sensor, a reed switch, a magnetic proximity sensor, and an optical [infrared ray, laser] sensor).

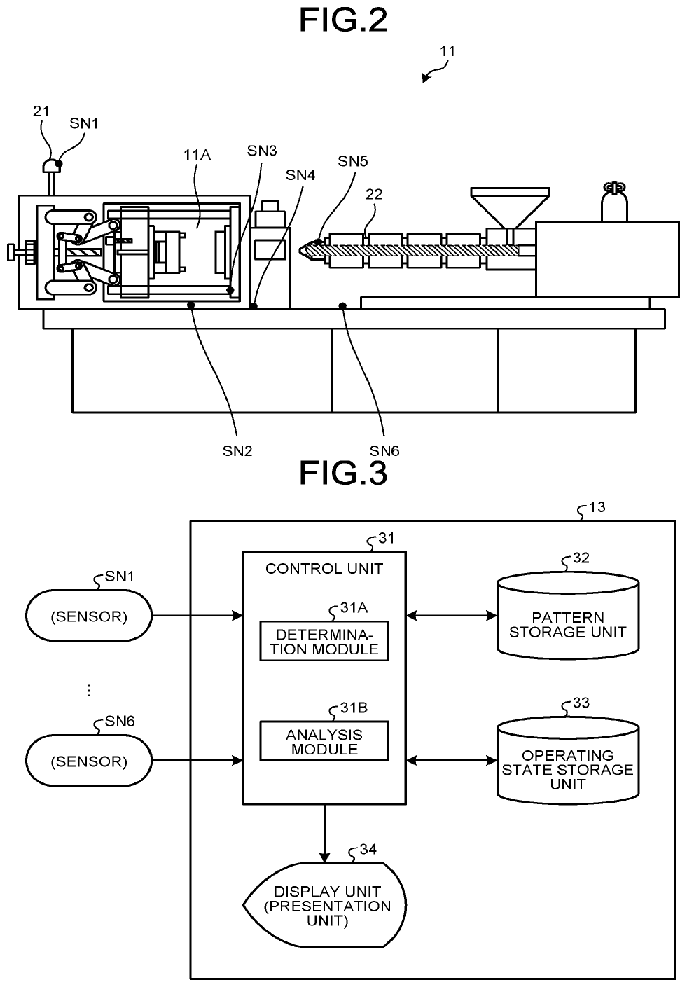

FIG. 2 is a layout diagram of sensors installed in an injection molding device.

In the vicinity of a beacon lamp 21 of the injection molding device 11, there is provided an illuminance sensor SN1 for determining turn-on/off of the beacon lamp 21.

In addition, in the vicinity of a mold housing 11A of the injection molding device, there is provided a TOF sensor SN2 for detecting human intrusion.

In addition, inside the mold housing 11A, there is provided a TOF sensor SN3 for detecting an opening amount of the mold and the presence or absence of the mold.

Furthermore, in the vicinity of the operation door of the mold housing 11A, there is provided a reed switch SN4 for detecting an open/closed state of the operation door.

In addition, there is provided a thermocouple SN5 in the vicinity of the head of an injection cylinder unit 22 of the injection molding device.

Furthermore, a magnetic proximity sensor SN6 for detecting the position of the injection cylinder unit 22 is provided below the injection cylinder unit 22.

FIG. 3 is a functional block diagram of the operating state management device.

The operating state management device 13 includes: a control unit 31 that performs overall control of the operating state management device 13; a pattern storage unit 32 that stores a feature pattern to be described below; an operating state storage unit 33 that stores operating states of the plurality of injection molding devices 11-11 to 11-13, 11-21 to 11-23, 11-31 to 11-33, and 11-41 to 11-43; and a display unit 34 that functions as a presentation unit and displays various types of information.

In the above configuration, the control unit 31 includes a determination module 31A that compares a pattern corresponding to the actual detection state of the plurality of sensors such as the illuminance sensor SN1, the TOF sensor SN2, the TOF sensor SN3, the reed switch SN4, the thermocouple SN5, and the magnetic proximity sensor SN6 with the feature pattern of the pattern storage unit 32 and then determines the operating state; and an analysis module 31B that analyzes a cause of loss in a predetermined time zone based on the operating states stored in time series.

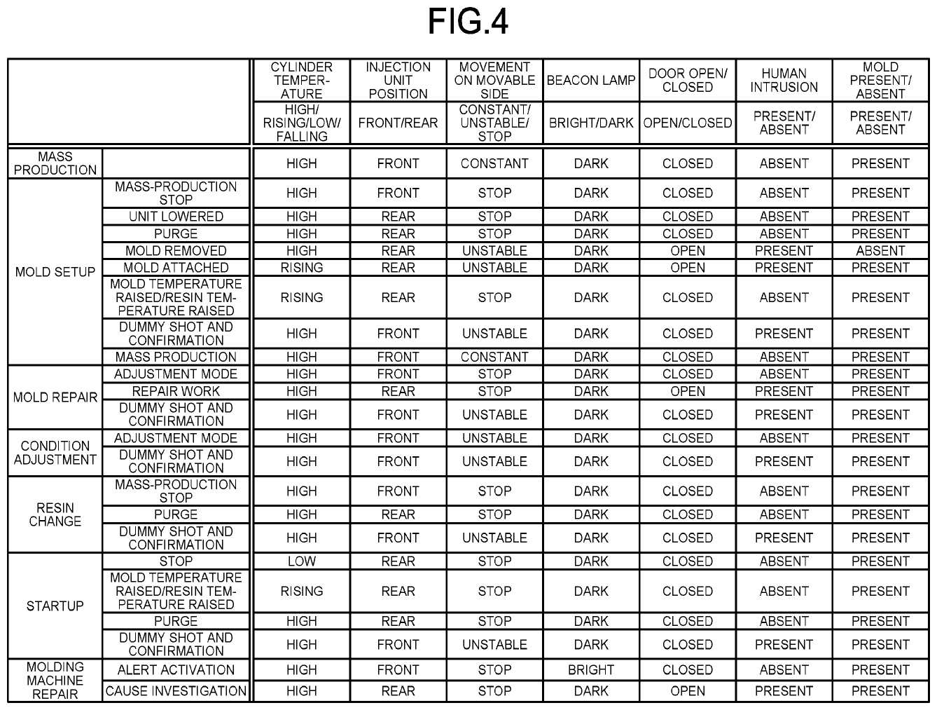

FIG. 4 is a diagram of a sensing target, a sensing position, and a sensing state for each of operating state management targets.

In this case, the cylinder temperature is determined in the following four stages.

Specifically, the four stages are: a “high” state in which the temperature is higher than a predetermined high-temperature side threshold; a “rising” state in which the temperature is rising in a state where the temperature is lower than the high-temperature side threshold; a “low” state in which the temperature is lower than a low-temperature side threshold; and a “falling” state in which the temperature is falling in a state where the temperature is higher than the low-temperature side threshold.

The determination of the position of the injection unit is made in the following two stages.

Specifically, the two stages are: a “front” position state corresponding to the position of the injection unit at the time of injection; and a “rear” position state corresponding to the position of the injection unit at the time of standby.

The determination of the movement on the movable side of the injection molding machine is made in the following three stages.

Specifically, the three stages are: a “constant” state corresponding to a state in which a constant motion is repeated; an “unstable” state corresponding to a state in which the position changes irregularly, such as at the time of maintenance; and a “stop” state corresponding to a state in which the machine stops with no motion.

The determination of the state of the beacon lamp is made in the following two stages.

Specifically, the two stages are: a “bright” state brighter than a predetermined high-temperature side threshold (high illuminance); and a “dark” state darker than the threshold (low illuminance).

The determination of the open/closed state of the operation door is made in the following two stages.

Specifically, the two stages are: an “open” state in which the operation door of the mold housing 11A is open which enables access to the mold; and a “closed” state in which the operation door of the mold housing 11A is closed which disables access to the mold.

The determination of the human intrusion state is made in the following two stages.

Specifically, the two stages are: an intrusion “present” state in which a human is detected within a predetermined detection range; and an intrusion “absent” state in which a human is not detected within the predetermined detection range.

The determination of the presence or absence of the mold is made in the following two stages.

Specifically, the two stages are: a “present” state in which the mold is disposed at a predetermined position; and an “absent” state in which the mold is not disposed at the predetermined position.

Here, an actual detection state will be described.

(0) At Mass Production

In the case of using a group of the above-described sensors, the settings in the case of mass production are: the cylinder temperature=“high”; the injection unit position=“front”; the movement on the movable side=“constant”; the beacon lamp=“dark”; the open/closed state of the operation door=“closed”; human intrusion=“absent”; and the presence or absence of the mold=“present”.

(1) At Mold Setup

In the case of mold setup, the following seven states can be detected.

The seven states are: a mass production stop state; a unit lowered state and a purge state; a mold removed (work) state; a mold attached (work) state; a mold temperature raised/resin temperature raised state; a dummy shot/confirmation state; and a mass production state.

Specifically, settings in the mass production stop state are: the cylinder temperature=“high”; the injection unit position=“rear”; the movement on the movable side=“constant”; the beacon lamp=“dark”; the open/closed state of the operation door=“closed”; human intrusion=“absent”; and the presence or absence of the mold=“present”.

The settings in the unit lowered state and the purge state are: the cylinder temperature=“high”; the injection unit position=“front”; the movement on the movable side=“stop”; the beacon lamp=“dark”; the open/closed state of the operation door=“open”; human intrusion=“present”; and the presence or absence of the mold=“present”.

The setting in the mold removed (work) state are: the cylinder temperature=“high”; the injection unit position=“rear”; the movement on the movable side=“unstable”; the beacon lamp=“dark”; the open/closed state of the operation door=“closed”; human intrusion=“absent”; and the presence or absence of the mold=“absent”.

The settings in the mold attached (work) state are: the cylinder temperature=“rising”; the injection unit position=“rear”; the movement on the movable side=“unstable”; the beacon lamp=“dark”; the open/closed state of the operation door=“closed”; human intrusion=“absent”; and the presence or absence of the mold=“present”.

The settings in the mold temperature raised/resin temperature raised state are: the cylinder temperature=“rising”; the injection unit position=“rear”; the movement on the movable side=“stop”; the beacon lamp=“dark”; the open/closed state of the operation door=“closed”; human intrusion=“absent”; and the presence or absence of the mold=“present”.

The settings in the dummy shot/confirmation state are: the cylinder temperature=“high”; the injection unit position=“front”; the movement on the movable side=“unstable”; the beacon lamp=“dark”; the open/closed state of the operation door=“closed”; human intrusion=“present”; and the presence or absence of the mold=“present”.

The settings in the mass production state are: the cylinder temperature=“high”; the injection unit position=“front”; the movement on the movable side=“constant”; the beacon lamp=“dark”; the open/closed state of the operation door=“closed”; human intrusion=“absent”; and the presence or absence of the mold=“present”.

(2) At Mold Breakage/Repair

In the case of mold breakage/repair, the following three states can be detected.

The three states are an adjustment mode state, a repair work state, and a dummy shot/confirmation state.

The settings in the adjustment mode state are: the cylinder temperature=“high”; the injection unit position=“front”; the movement on the movable side=“stop”; the beacon lamp=“dark”; the open/closed state of the operation door=“closed”; human intrusion=“absent”; and the presence or absence of the mold=“present”.

The settings in the repair work state are: the cylinder temperature=“high”; the injection unit position=“rear”; the movement on the movable side=“stop”; the beacon lamp=“dark”; the open/closed state of the operation door=“open”; human intrusion=“present”; and the presence or absence of the mold=“present”.

The settings in the dummy shot/confirmation state are: the cylinder temperature=“high”; the injection unit position=“front”; the movement on the movable side=“unstable”; the beacon lamp=“dark”; the open/closed state of the operation door=“closed”; human intrusion=“present”; and the presence or absence of the mold=“present”.

(3) At Molding Condition Adjustment

In the case of the molding condition adjustment, the following two states can be detected.

The two states are an adjustment mode state and a dummy shot/confirmation state.

The settings in the adjustment mode state are: the cylinder temperature=“high”; the injection unit position=“front”; the movement on the movable side=“unstable”; the beacon lamp=“dark”; the open/closed state of the operation door=“closed”; human intrusion=“absent”; and the presence or absence of the mold=“present”.

The settings in the dummy shot/confirmation state are: the cylinder temperature=“high”; the injection unit position=“front”; the movement on the movable side=“unstable”; the beacon lamp=“dark”; the open/closed state of the operation door=“closed”; human intrusion=“present”; and the presence or absence of the mold=“present”.

(4) At Resin Change

In the case of resin change, the following three states can be detected.

The three states are a mass production stop state, a purge state, and a dummy shot/confirmation state.

The settings in the mass production stop state are: the cylinder temperature=“high”; the injection unit position=“front”; the movement on the movable side=“stop”; the beacon lamp=“dark”; the open/closed state of the operation door=“closed”; human intrusion=“absent”; and the presence or absence of the mold=“present”.

The settings in the purge state are: the cylinder temperature=“high”; the injection unit position=“rear”; the movement on the movable side=“stop”; the beacon lamp=“dark”; the open/closed state of the operation door=“closed”; human intrusion=“absent”; and the presence or absence of the mold=“present”.

The settings in the dummy shot/confirmation state are: the cylinder temperature=“high”; the injection unit position=“front”; the movement on the movable side=“unstable”; the beacon lamp=“dark”; the open/closed state of the operation door=“closed”; human intrusion=“present”; and the presence or absence of the mold=“present”.

(5) At Pre-Mass-Production Startup

In the case of pre-mass-production startup, the following four states can be detected.

The four states are a stop state, a mold/resin temperature raised state, a purge state, and a dummy shot/confirmation state.

The settings in the stop state are: the cylinder temperature=“low”; the injection unit position=“rear”; the movement on the movable side=“stop”; the beacon lamp=“dark”; the open/closed state of the operation door=“closed”; human intrusion=“absent”; and the presence or absence of the mold=“present”.

The settings in the mold/resin temperature raised state are: the cylinder temperature=“rising”; the injection unit position=“rear”; the movement on the movable side=“stop”; the beacon lamp=“dark”; the open/closed state of the operation door=“closed”; human intrusion=“absent”; and the presence or absence of the mold=“present”.

The settings in the purge state are: the cylinder temperature=“high”; the injection unit position=“rear”; the movement on the movable side=“stop”; the beacon lamp=“dark”; the open/closed state of the operation door=“closed”; human intrusion=“absent”; and the presence or absence of the mold=“present”.

The settings in the dummy shot/confirmation state are: the cylinder temperature=“high”; the injection unit position=“front”; the movement on the movable side=“unstable”; the beacon lamp=“dark”; the open/closed state of the operation door=“closed”; human intrusion=“present”; and the presence or absence of the mold=“present”.

(6) At Molding Machine Failure

In the case of a molding machine failure, the following two states can be detected.

The two states are an alert activation state and a cause investigation state.

The settings in the alert activation state are: the cylinder temperature=“high”; the injection unit position=“front”; the movement on the movable side=“stop”; the beacon lamp=“dark”; the open/closed state of the operation door=“closed”; human intrusion=“absent”; and the presence or absence of the mold=“present”.

The settings in the cause investigation state are: the cylinder temperature=“high”; the injection unit position=“rear”; the movement on the movable side=“stop”; the beacon lamp=“dark”; the open/closed state of the operation door=“closed”; human intrusion=“present”; and the presence or absence of the mold=“present”.

Here, an actual process in the mold setup will be described.

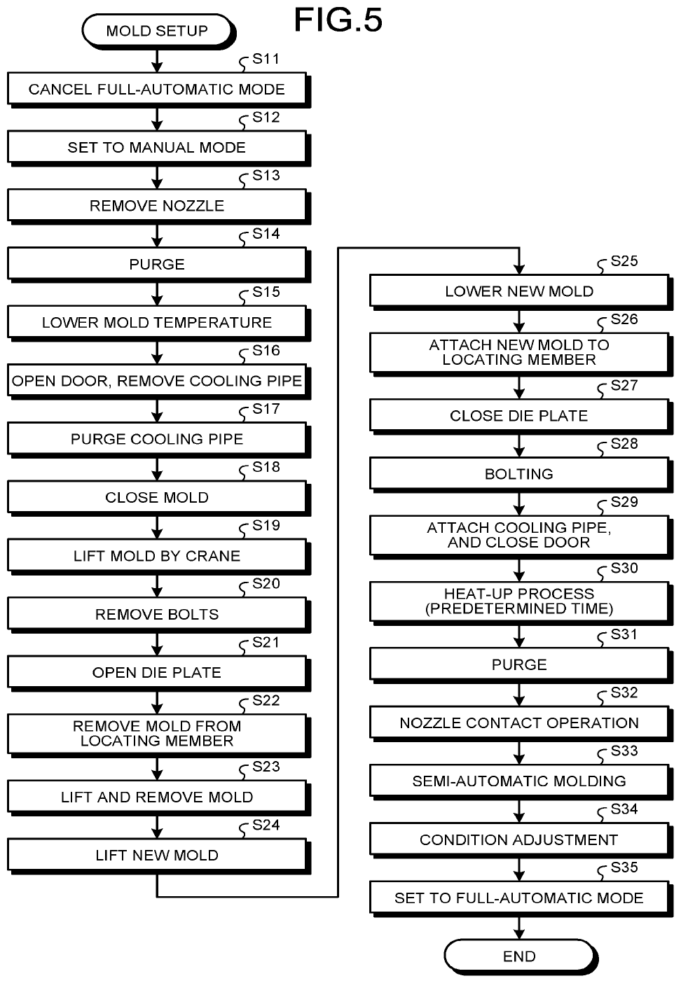

FIG. 5 is a process chart of the mold setup.

In the mold setup, the operator operates the operating state management device 13 to cancel the full-automatic mode of the operation mode of the injection molding device 11 to be subjected to the mold setup (step S11).

With this operation, the operating state management device 13 detects that the full-automatic mode of the injection molding device 11 has been cancelled.

Furthermore, the operator sets the operation mode of the injection molding device 11 to the manual mode (step S12).

Subsequently, the operator removes the nozzle of the injection molding device 11 (step S13) and performs purging (step S14).

Subsequently, the temperature of the mold is lowered in order to remove the mold (step S15).

Subsequently, an operation door of the mold housing 11A is opened, and a cooling pipe is removed from the mold (step S16).

Next, the operator purges the cooling pipe (step S17).

After completion of the purging, the operator sets the mold to the closed state (step S18).

Next, the operator uses a crane to lift the mold so as to prevent the mold from falling when the mold is removed (step S19).

Subsequently, the operator removes bolts fixing the mold (step S20) and opens a die plate (step S21).

Furthermore, the operator removes the mold from a locating member (step S22).

At this stage, since the mold is in a free state, the mold is lifted by the crane and removed from the injection molding device 11 (step S23).

Subsequently, the operator uses the crane to lift a new mold to be attached (step S24), and lowers the new mold to a predetermined attachment position (step S25).

Next, the operator attaches the new mold to the locating member (step S26).

Subsequently, the operator closes the die plate (step S27) and fixes the new mold by bolting the mold (step S28).

Subsequently, the cooling pipe is attached to the new mold, and the operation door of the mold housing 11A is closed (step S29).

Subsequently, the operator operates an operation panel (not illustrated) to perform a heat-up process of heating the new mold for a predetermined time (step S30).

Next, the operator purges the molded resin (step S31), performs nozzle contact operation after the purging is finished (step S32), and performs semi-automatic molding to confirm an actual molding state (step S33).

The operator adjusts injection molding conditions such as an injection temperature and an injection speed based on a result of the semi-automatic molding (step S34).

The operator repeats semi-automatic molding (step S33) and adjustment of the injection molding conditions (step S34) as necessary. When the optimum injection conditions are obtained, the operator operates the operating state management device 13 to set the operation mode of the injection molding device 11 to the full-automatic mode and ends the process (step S35).

As a result, the operating state management device 13 shifts to the normal operating state management state.

Hereinafter, a method of determining the operating state of the operating state management device 13 will be described.

In the present embodiment, as described above, the operating state management device 13 determines the operating states including: the mass production state; the mold setup state; the mold breakage/repair state; the molding condition adjustment state; the resin change state; the pre-mass-production startup state; the molding machine failure state; and other states.

Hereinafter, specific determination of the operating state management device 13 will be described with reference to the drawings.

First, determination at the time of mass production will be described.

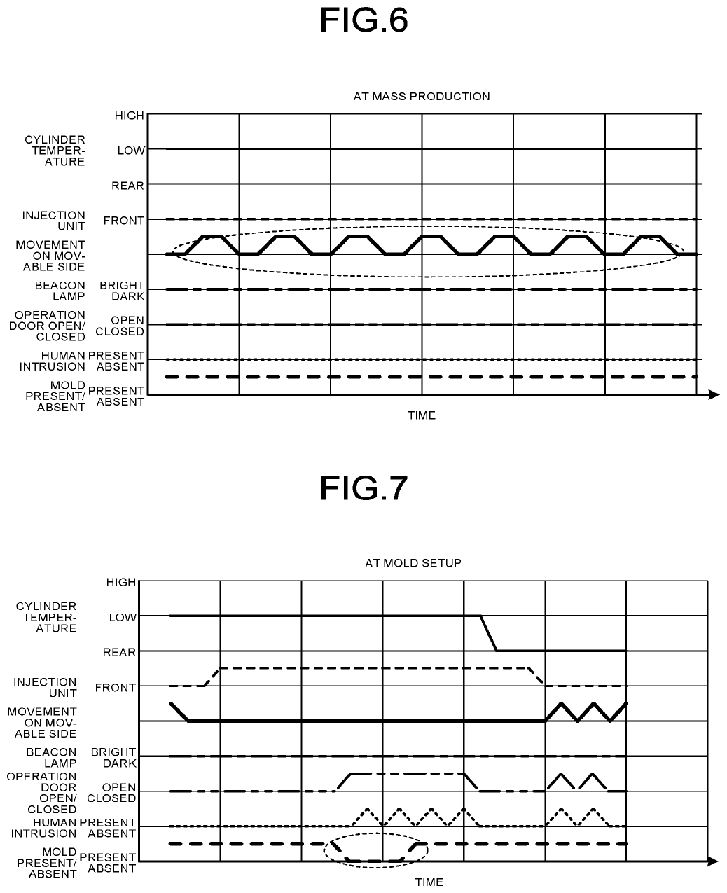

FIG. 6 is a diagram illustrating a feature pattern corresponding to a detection state of each of sensors at the time of mass production.

As indicated by a dashed ellipse in FIG. 6, the most notable point at the time of mass production is that the movement on the movable side (linked with the mold opening amount) detected by the TOF sensor SN3 is made at constant intervals.

The other points are at constant levels.

Therefore, the operating state management device 13 functions as a determination module, and when the movement on the movable side (linked with the mold opening amount) detected by the TOF sensor SN3 is at constant intervals, the operating state management device 13 provisionally determines that the operating state is the mass production state.

Subsequently, after confirming that other points are at constant levels, the operating state management device 13 finally determines that the operating state is the mass production state.

Next, the determination at the time of mold setup will be described.

FIG. 7 is a diagram illustrating a feature pattern corresponding to a detection state of each of sensors at the time of mold setup.

As indicated by a dashed ellipse in FIG. 7, the most notable point at the time of mold setup is a transition from a state where the mold is present to a state where the mold is absent in the mold presence/absence detection by the TOF sensor SN3.

Therefore, the operating state management device 13 functions as a determination module, and determines that the operation state is the mold setup state when a transition has been made from the mold presence to the mold absence state in the mold presence/absence detected by the TOF sensor SN3.

Next, determination at the time of mold breakage/repair will be described.

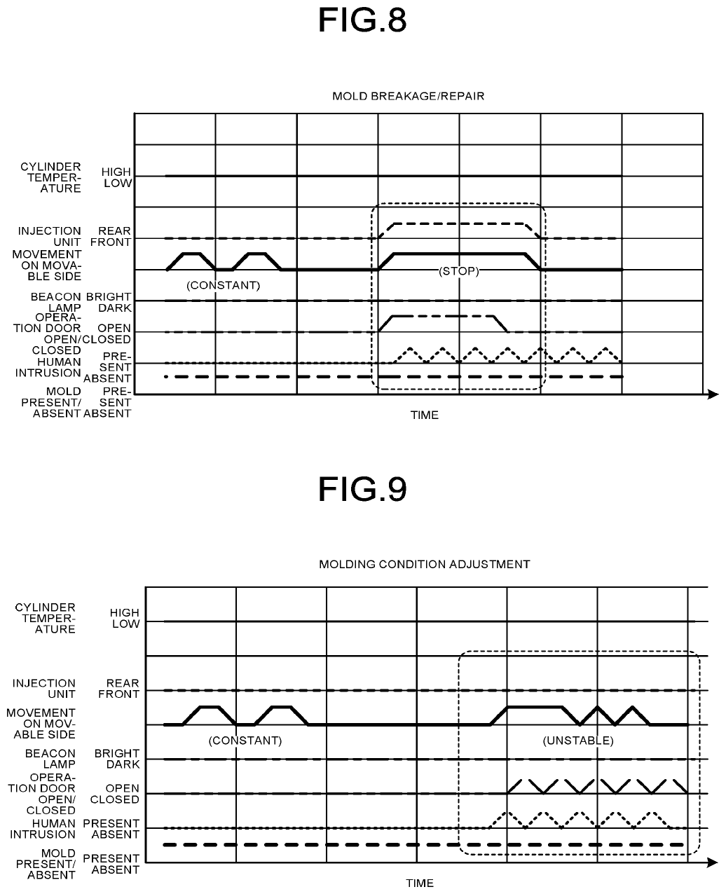

FIG. 8 is a diagram illustrating a feature pattern corresponding to a detection state of each of sensors at the time of mold breakage/repair.

As indicated by a dashed rectangle in FIG. 8, the settings at the time of mold breakage/repair are: the position of the injection cylinder unit 22 detected by the magnetic proximity sensor SN6 is rear being an injection disabled position; the movement on the movable side (linked with the mold opening amount) detected by the TOF sensor SN3 is in a stop state; the operation door detected by the reed switch SN4 is in an open state which is the injection prohibited state; and regarding the human intrusion detected by the TOF sensor SN2, the presence/absence of human intrusion is irregularly repeated.

Therefore, the operating state management device 13 functions as a determination module, and when the above state is detected, the operating state management device 13 determines that the operating state is the mold breakage/repair state.

Next, determination at the time of molding condition adjustment will be described.

FIG. 9 is a diagram illustrating a feature pattern corresponding to a detection state of each of sensors at the time of adjusting a molding condition.

As indicated by a dashed rectangle in FIG. 9, points to be noted at the time of the molding condition adjustment are that: the movement on the movable side (linked with the mold opening amount) detected by the TOF sensor SN3 is unstable; the operation door detected by the reed switch SN4 repeats an open state being the injection prohibited state and a closed state being the injection enabled state; and regarding the human intrusion detected by the TOF sensor SN2, the presence/absence of human intrusion is irregularly repeated.

Therefore, the operating state management device 13 functions as a determination module. When the above state is detected, the operating state management device 13 determines that the operating state is the molding condition adjustment state.

Next, determination at the time of resin change will be described.

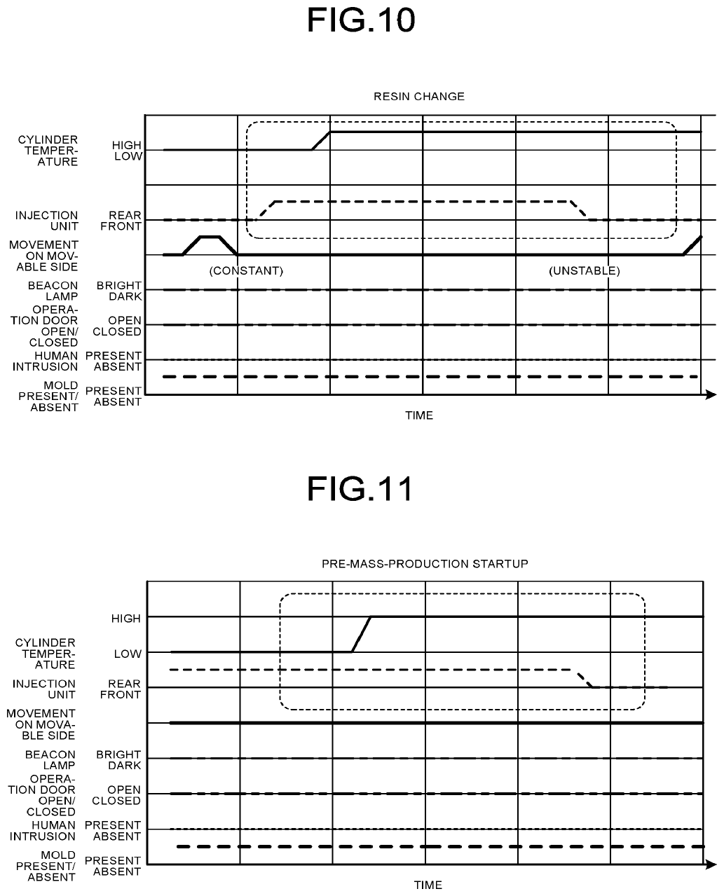

FIG. 10 is a diagram illustrating a feature pattern corresponding to a detection state of each of sensors at the time of resin change.

As indicated by a dashed rectangle in FIG. 10, points to be noted at the time of resin change are that: the position of the injection cylinder unit 22 detected by the magnetic proximity sensor SN6 moves from the front to the rear; and thereafter, the temperature of the injection cylinder unit 22 detected by the thermocouple SN5 transitions from a low temperature (temperature lower than a predetermined threshold temperature at which injection molding can be performed) to a high temperature (temperature higher than the predetermined threshold temperature).

Therefore, the operating state management device 13 functions as a determination module. When the above state is detected, the operating state management device 13 determines that the operating state is the resin change state.

Next, determination at pre-mass-production startup will be described.

FIG. 11 is a diagram illustrating a feature pattern corresponding to a detection state of each of sensors at the time of pre-mass-production startup.

As indicated by a dashed rectangle in FIG. 11, points to be noted at the time of pre-mass-production startup are that: the temperature of the injection cylinder unit 22 detected by the thermocouple SN5 has transitioned from a low temperature (temperature lower than a predetermined threshold temperature at which injection molding can be performed) to a high temperature (temperature higher than a predetermined threshold temperature); and thereafter the position of the injection cylinder unit 22 detected by the magnetic proximity sensor SN6 has moved from the rear to the front.

Therefore, the operating state management device 13 functions as a determination module, and when the above state is detected, the operating state management device 13 determines that the operating state is the pre-mass-production startup state.

Next, determination at the time of molding machine failure (alarm activation) will be described.

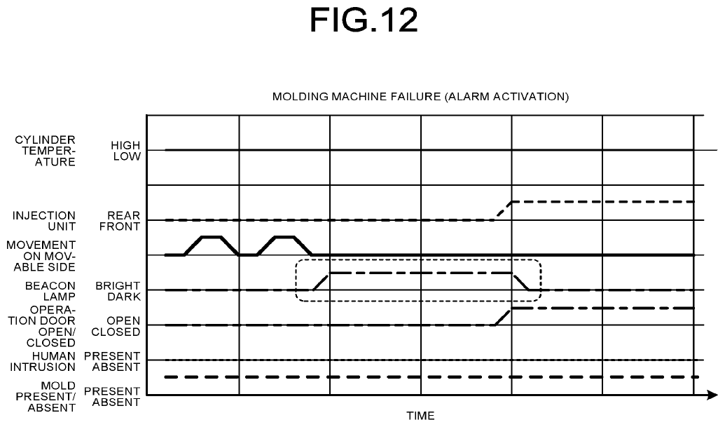

FIG. 12 is a diagram illustrating a feature pattern corresponding to a detection state of each of sensors at the time of a molding machine failure (alarm activation).

As indicated by a dashed rectangle in FIG. 12, a point to be particularly noted at the time of a molding machine failure (alarm activation) is that the brightness of the beacon lamp 21 detected by the illuminance sensor SN1 has transitioned from dark (off) to bright (on).

Therefore, the operating state management device 13 functions as a determination module, and when a state in which the brightness of the beacon lamp 21 has transitioned from dark (off) to bright (on) is detected, the operating state management device 13 determines that the operating state is a molding machine failure (alarm activation) state.

Next, processes at the time of operation of the operating state management device 13 will be described.

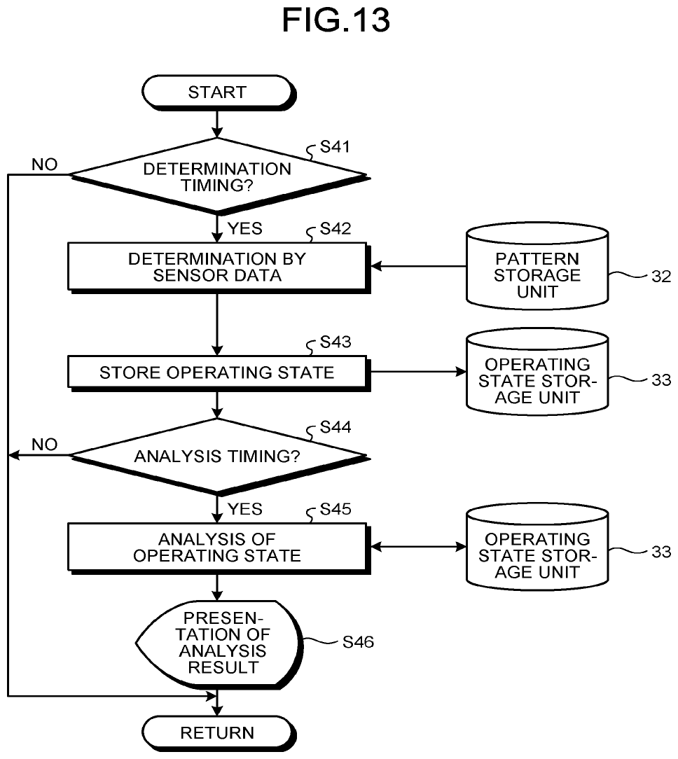

FIG. 13 is a processing flowchart at the time of operation of the operating state management device 13.

First, the control unit 31 of the operating state management device 13 determines at predetermined time intervals whether it is a determination timing of the operating state (step S41).

When having determined in step S41 that it is not the determination timing yet (step S41; No), the operating state management device 13 ends the process.

In a case where it is determined in step S41 that it is the determination timing (step S41; Yes), the determination module 31A of the control unit 31 compares the pattern corresponding to the actual detection state of the plurality of sensors such as the illuminance sensor SN1, the TOF sensor SN2, the TOF sensor SN3, the reed switch SN4, the thermocouple SN5, and the magnetic proximity sensor SN6 with the feature pattern of the pattern storage unit 32 and then determines the operating state (step S42).

Subsequently, the control unit 31 stores a result of the determination in the operating state storage unit 33 in time series (step S43).

Subsequently, the control unit 31 determines whether it is an operating state analysis timing (step S44).

When having determined in step S44 that it is not the operating state analysis timing yet (step S44; No), the control unit 31 ends the process.

When it is determined in step S44 that it is the operating state analysis timing (step S44; Yes), the control unit 31 performs the loss cause analysis in a predetermined time zone with reference to the operating state storage unit 33 again based on the operating states stored in time series (step S45).

Subsequently, the control unit 31 displays the analysis result on the display unit 34 functioning as a presentation unit (step S46).

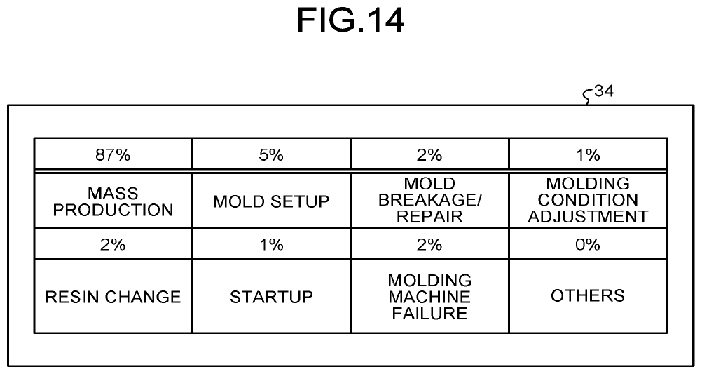

FIG. 14 is a diagram illustrating a display example of an analysis result.

The exemplary case of FIG. 14 illustrates the occurrence ratios of the loss causes within a predetermined time for each of the causes displayed on a display screen of the display unit 34.

For example, the example of FIG. 14 indicates that the operating state in mass production is 87%, the loss due to mold setup is 5%, the loss due to mold breakage/repair is 2%, the loss due to molding condition adjustment is 1%, the loss due to resin change is 2%, the loss due to startup is 1%, the loss due to molding machine failure is 2%, and the loss due to other reasons is 0%.

In this manner, it is possible to easily grasp the loss ratio with respect to the mass production (normal operation) ratio as the operating state together with the main loss factor, and to grasp the accurate operating rate.

This makes it possible to facilitate improvement of work and the like, reduction of loss time, and enhancement of productivity and the operating rate.

Note that the display mode is an example, and not only numerical value display but also any display mode such as display of a circular graph, a bar graph, or the like, monthly display, weekly display, or the like can be used.

Although the generation of the feature pattern has not been described in detail in the above description, it is also allowable to store feature patterns obtained by applying patterning using machine learning or the like on the sensed waveforms.

Although the above description is an example of the injection molding machine that molds resin as the target of the operating state management, the present technology can be similarly applied to a die casting machine that molds aluminum by die casting.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An operating state management device comprising:
a first memory configured to store, in each of a plurality of operating state management target devices, feature patterns of detection states of a plurality of sensors that detect states of individual components in association with operating states;
a processor configured to compare patterns corresponding to actual detection states of the plurality of sensors with the feature patterns stored in the first memory, and determine operating states; and
a second memory configured to store the determined operating states in time series.

2. The operating state management device according to claim 1, wherein
the processor is configured to perform an analysis of a loss cause in a predetermined time zone based on the operating states stored in time series.

3. The operating state management device according to claim 2, wherein the processor is configured to calculate an operating rate for each of the operating state management target devices based on a result of the analysis.

4. The operating state management device according to claim 2, further comprising:
a presentation unit configured to present a result of the analysis performed by the processor.

5. An operating state management system comprising:
a plurality of sensors that are provided in each of a plurality of operating state management target devices, the plurality of sensors detecting states of individual components;
an operating state management device including:
a first memory configured to store feature patterns of detection states of the sensors in association with operating states;
a processor configured to compare patterns corresponding to actual detection states of the plurality of sensors with the feature patterns stored in the first memory, and determine operating states; and
a second memory configured to store the determined operating states in time series, the processor being configured to perform an analysis of a loss cause in a predetermined time zone based on the operating states stored in time series; and
a display device configured to present a result of the analysis performed by the processor.

6. An operating state management method executed by an operating state management device configured to perform operating state management based on detection states of a plurality of sensors, the plurality of sensors being provided in each of a plurality of operating state management target devices and detecting states of individual components,
the operating state management method comprising:
storing in advance feature patterns of detection states of the sensors in association with operating states;
comparing patterns corresponding to actual detection states of the plurality of sensors with the feature patterns and determining operating states;
storing the determined operating states in time series;
performing an analysis of a loss cause in a predetermined time zone based on the operating states stored in time series; and
presenting a result of the analysis.
